(19) United States
(12) Patent Application Publication
(10) Pub. No.: US 2023/0219765 A1
(43) Pub. Date: Jul. 13, 2023

(54) CONVEYOR SYSTEMS

(71) Applicant: George Terah GOUGH, Fort Mill, SC (US)

(72) Inventor: George Terah GOUGH, Fort Mill, SC (US)

(21) Appl. No.: 18/009,026

(22) PCT Filed: Jun. 8, 2021
(86) PCT No.: PCT/IB2021/055040

§ 371 Date: Dec. 8, 2022

Related U.S. Application Data
(60) Provisional application No. 63/036,023, filed on Jun. 8, 2020.

(51) Int. Cl. B65G 17/12; B65G 47/40

(52) U.S. Cl. CPC B65G 17/126; B65G 47/40; B65G 2812/02643

(57) ABSTRACT

A conveyor system, comprising: a track containing an endless chain (2); and a plurality of buckets (4) each bucket (4) comprising a bucket body defining a void in which contents can be contained, an arm (51) pivotally mounted on the bucket body through a mounting for rotation relative to the bucket body about a bucket pivot axis (50) through the mounting, the arm (51) extending perpendicular to the bucket pivot axis (50) and having an arm head (16) at point distant from the axis; each arm head being fixed to the chain through an arm mounting, the arm mountings being spaced apart along the endless chain by a chain pitch, whereas the endless chain follows a first path, and the mountings of the buckets follow a second path; and in which variation of the radius of curvature of the first path relative to the second path causes a separation of the buckets to vary.

### CROSS-REFERENCE TO RELATED APPLICATIONS

This application claims the benefit of International application number PCT/IB2021/055040, filed Jun. 8, 2021, which claims the benefit of U.S. Provisional Application No. 63/036,023, filed Jun. 8, 2020, which are incorporated by reference as if disclosed herein in their entireties.

### TECHNICAL FIELD

This invention relates to conveyor systems, such as bucket conveyors.

This invention relates to conveyor systems, typically of the bucket type. The majority of such systems comprise an endless chain carrying a plurality of buckets pivotally or otherwise attached to the chain at intervals and extending through loading stations and discharge stations.

### BACKGROUND

Such Conveyors have the disadvantage that if considerable spillage at the loading station is to be avoided, intermittent operation of means of filling the buckets must be provided due to gaps between buckets.

It has been proposed to overcome this problem by providing arrangements which enable the buckets to be closed together and into abutting relationship at the filling station, for example by temporally shortening of the chain runs between the Buckets.

Such arrangements necessarily add considerable complexity to, and detract from the robustness of the apparatus; moreover, difficulties would arise in the application of such arrangement to conveyors using chains of bi or multi planar type (where the path is not constrained to a single plane and permit a conveyor run to follow a three dimensional path).

As such, it is desirable to provide a conveyor system suitable for continuous loading without spillage in which no provision need be made for shortening the chain runs between the buckets at the filling station, and which can be adapted to follow a three-dimensional path.

### BRIEF SUMMARY

According to a first aspect of the invention, we provide a conveyor system, comprising:

a track containing an endless chain; and

a plurality of buckets

each bucket comprising a bucket body defining a void in which contents can be contained, an arm pivotally mounted on the bucket body through a mounting for rotation relative to the bucket body about a bucket pivot axis through the mounting, the arm extending perpendicular to the bucket pivot axis and having an arm head at point distant from the axis;

each arm head being fixed to the chain through an arm mounting, the arm mountings being spaced apart along the endless chain by a chain pitch,

whereas the endless chain follows a first path, and the mountings of the buckets follow a second path; and

in which variation of the radius of curvature of the first path relative to the second path causes a separation of the buckets to vary.

As such, this allows the separation of the buckets to be varied by varying the radius of curvature of the first path relative to the second path. For example, by making the first path have a greater radius of curvature than the second path—for example, by having the mounting points of the buckets travel around the inside of a curve in the track, with the track on the outside, the buckets can be moved together (for example to allow for material to be dispensed into them). The buckets can be moved apart (e.g. for dispensing material out of the buckets) by having the paths equal in curvature (e.g. on a straight where the paths would be parallel) or with the radius of curvature of the second path be greater (by having the mountings on the outside of a curve in the track).

Typically the chain pitch will be fixed. However, a variable pitch chain can be used; by compressing the chain, the pitch can be decreased where desired (e.g. to reduce the separation of the buckets).

The track may comprise a guide arranged to guide the arm mountings. Typically, the guide may control the angle of each arm relative to the track. The guide may define at least one channel, with each arm mounting having at least one guide portion, such as a guide wheel, working in each channel. The guide channel may comprise a plurality of tubular sections such as tubes (typically of circular but potentially any cross section) with each channel formed between a pair of tubular sections. Typically, there will be four tubular sections defining three channels.

According to a second aspect of the invention, we provide a conveyor system, comprising:

a track containing an endless chain; and

a plurality of buckets

each bucket comprising a bucket body defining a void in which contents can be contained, an arm pivotally mounted on the bucket body through a mounting for rotation relative to the bucket body about a bucket pivot axis through the mounting;

each arm head being fixed to the chain through an arm mounting, the arm mountings being spaced apart along the endless chain by a variable chain pitch,

whereas the endless chain follows a first path,

in which variation of the chain pitch causes a separation of the buckets to vary.

As such, this provides an alternative solution to the issue of bucket separation.

The track may comprise a guide arranged to guide the arm mountings. Typically, the guide may control the angle of each arm relative to the track. The guide may define at least one channel, with each arm mounting having at least one guide portion, such as a guide wheel, working in each channel. The guide channel may comprise a plurality of tubular sections such as circular tubes (although any cross section is possible) with each channel formed between a pair of tubular sections. Typically, there will be four tubular sections defining three channels. This may allow bi-planar operation.

For either of the above aspects, each bucket may comprise a rotation means arranged to rotate it about the bucket pivot axis. The conveyor system may further comprise at least one engagement means arranged to engage each rotation means so as to cause each bucket to rotate; this is particularly useful where material is to be discharged from the buckets. Typically, each engagement means will not use its own motion to cause rotation of the buckets; instead, the engagement means will convert motion of each bucket past the engagement means due to movement of the endless chain along the track into rotation of each bucket.

In some embodiments, the rotation means may each comprise a gear mounted on the bucket, a cam or a follower. Where the rotation means comprises a gear, the engagement means may comprise a toothed rack.

Each engagement means may have an operative position where it can engage the rotation means and an inoperative position where it does not. An actuator, such as a piston, may be provided arranged to move the engagement means between the operative and inoperative positions.

At least one of the rotation means and the engagement means may be arranged so as to introduce a dwell period of no or limited rotational movement of each bucket between two periods of rotational movement caused by the engagement means. As an example, where the rotation means comprises a gear and the engagement means comprises a toothed rack, the toothed rack may have a plain section between two toothed sections, so that the bucket does not rotate whilst the plain section is passing the rotation means. This allows for a bucket to be held in, for example, an unloading position whilst the contents are dispensed.

Each bucket may comprise a lip which, in at least one position of the buckets (typically a position with the buckets moved together), overlays an edge of a following bucket on the endless chain. As such, when the buckets come together, a continuous surface can be presented for the material dispensed into the buckets.

Whilst it is possible that the first path may lie entirely within a single plane, it is possible that the first path does not lie in a single plane. This is because the track (and in particular the guide where used) allows for the support of the buckets from one end only, which allows for both movement in one plane (e.g. vertical) and another (e.g. horizontal). As such, each bucket may be cantilevered from its mounting. Typically, the first path will be perpendicular to the bucket pivot axis at each point over the first path, or at least a majority of the first path.

The bucket mounting may comprise a frame in which the bucket body sits. The frame may surround the bucket body. The bucket body may be made from a plastic material, whereas the frame may be formed of metal material. This is both easy and cheap to manufacture. Furthermore, the frame can add additional strength to the bucket, which can be desirable where the bucket is cantilevered.

### BRIEF DESCRIPTION OF THE DRAWINGS

There now follows by way of example only, description of embodiments of the present and invention, described with reference to the accompanying drawings, in which:

FIG. 1 shows a cross section through a bucket of a conveyor system in accordance with an embodiment of the present invention;

FIG. 2 shows an enlarged cross section through the chain and guide of the conveyor system of FIG. 1;

FIG. 3 shows an elevation of a possible arrangement of the conveyor system of FIG. 1 passing a feeding station;

FIG. 4 shows an elevation of a different possible arrangement of the conveyor system of FIG. 1 passing a feeding station;

FIG. 5 shows a perspective transparent view of the bucket of FIG. 1;

FIGS. 6a and 6b show two elevations of alternative embodiments of the conveyor system passing a discharge station;

FIG. 7 show an elevation of a toothed rack for use in the conveyor of FIGS. 6a and 6b at a discharge station;

FIG. 8 shows a perspective view of the conveyor system of FIGS. 6a and 6b.

FIG. 9 show an elevation of an alternative embodiment of the sprocket and rack of FIGS. 6a and 6b again for use in a discharge station;

FIG. 10 shows an elevation of the chain used in the embodiments of FIGS. 1 to 9;

FIG. 11 show an elevation of a conveyor system in accordance with an embodiment of the invention;

FIG. 12 shows an elevation of a sprocket wheel used in the conveyor system of FIG. 11;

FIG. 13 shows an elevation of the sprocket wheel of FIG. 12 as traversed by the conveyor system of FIG. 11;

FIGS. 14 to 16 show plan views of the sprocket wheel of FIG. 12 as traversed by the conveyor system of FIG. 11

FIGS. 17a and 17b show elevation and plan views of an example link used in the chain of FIG. 10;

FIG. 18 shows a cross section through a bucket of a conveyor system in accordance with a further embodiment of the present invention;

FIG. 19 shows a perspective view of the conveyor system of FIG. 18;

FIG. 20 shows a plan view of the chain of the conveyor system of FIG. 18;

FIG. 21 shows a further perspective view of the conveyor system of FIG. 18;

FIG. 22 shows a cross section of a bucket for use with the above embodiments;

FIG. 23 shows a perspective view of the support frame for the bucket of FIG. 22;

FIG. 24 shows a perspective view of a bracket for use with a further bucket for use with the above embodiments; and

FIG. 25 shows a perspective view of the bucket for use with the bracket of FIG. 24.

### DETAILED DESCRIPTION OF THE DISCLOSURE

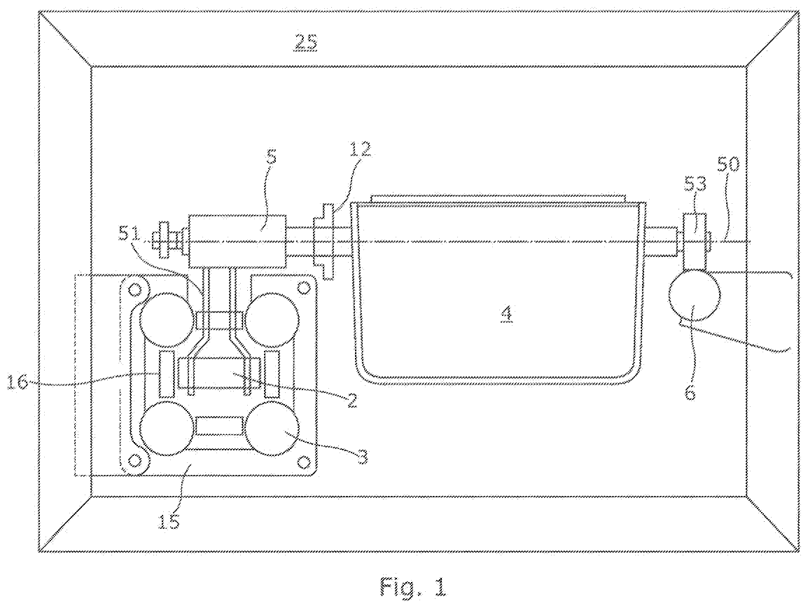

A conveyor system in accordance with a first embodiment of the invention is shown in FIGS. 1 to 5 of the accompanying drawings. It comprises an endless chain 2 within a guide 15. A plurality of buckets 4 are suspended from the chain 2. Each bucket 4 is mounted on the chain through an integral spindle 5 which allows rotation about axis 50. The spindle 5 mounts the bucket 4 on an arm 51 which extends perpendicular to axis 50. The arm 51 terminates within the guide 15 attached to chain 2 through an arm head 16 which (as which will be explained below) keeps the arm in a desired orientation relative to the guide 15, although the buckets can pivot about spindle 5 and axis 50.

As such, each bucket 4 is supported on one side through the arm 51 on the chain 2. On the distal side there can provided a further support 6 on which a wheel 53 attached to bucket 4 can roll; alternatively, the buckets 4 can simply be cantilevered off the chain 2.

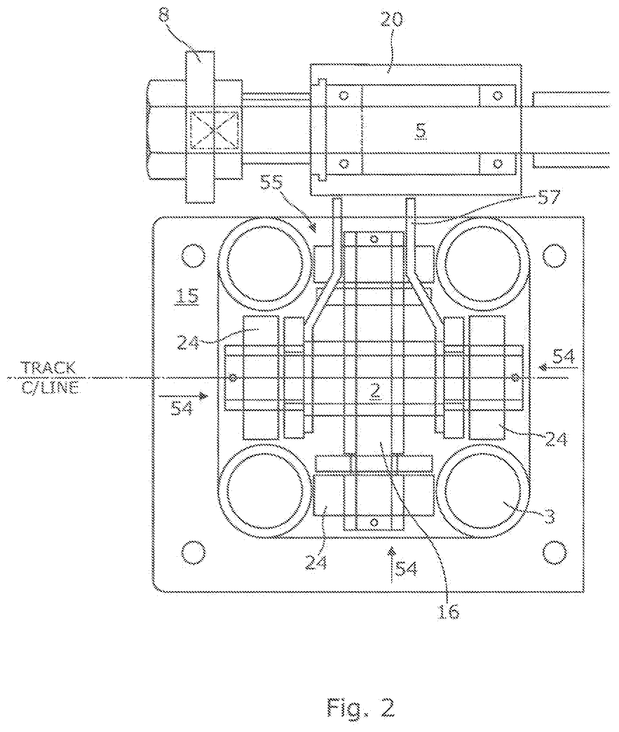

The guide 15 can be seen in more detail in FIG. 2 of the accompanying drawings. The guide 15 comprises four tubular members 3 which define channels 54 between (and an access aperture 55 for arm 51) between them. In each channel 54 the arm head 16 comprises a load wheel 24 as well as being attached to the chain 2; as such, the wheels will restrict the movement of the arm 51 to being in a particular orientation relative to the tubular members 3, typically such that the arm 51 emerges perpendicularly from the guide 15.

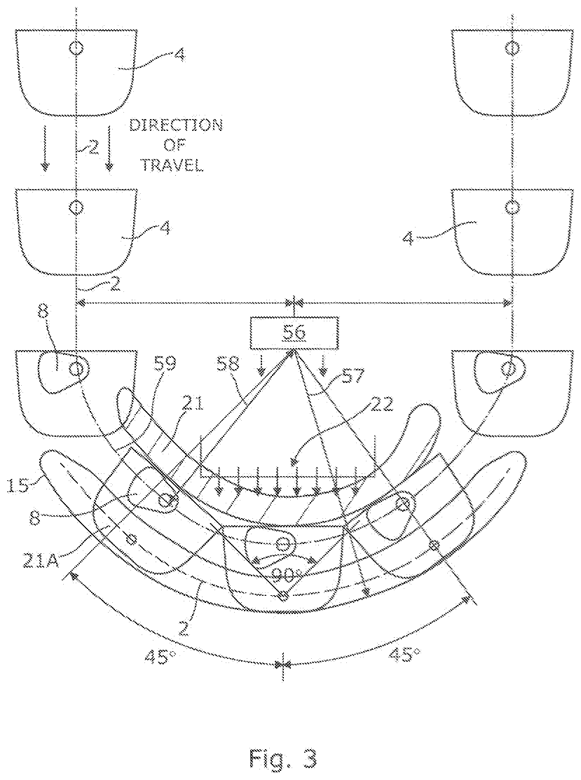

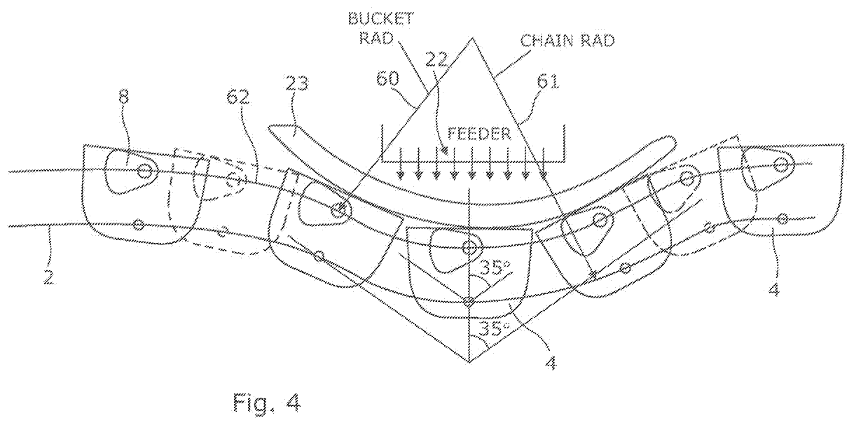

The operation of the conveyor system can be seen in FIGS. 3 and 4 of the accompanying drawings. As can be seen, each of the buckets 4 is provided with a cam 8. This follows a cam surface 21 so that, as the (endless) chain 2 rotates around its path, it the cam 8 engages the cam surface 8 so as to rotate the buckets. As can be seen in FIG. 3, this allows the buckets to be orientated to catch material from filling station 56.

In particular, it is to be noted that the radius 57 of curvature of the chain 2 is greater than the radius of curvature 58 of the path 59 followed by the spindles 5 about which the buckets rotate. This brings the buckets close together, leaving no gap between the buckets.

Whilst in FIG. 3 the path of the chain 2 to and from the filling station 56 was vertical, it is equally possible to have the path horizontal as shown in FIG. 4 of the accompanying drawings. Again, the cam 8 follows cam surface 23 to rotate the buckets 4 appropriately, whereas the increased radius of curvature 61 of the chain 2 rather than the radius of curvature 60 of the path 62 followed by the spindles 5 brings the buckets 4 together to receive material from controlled feeder 22.

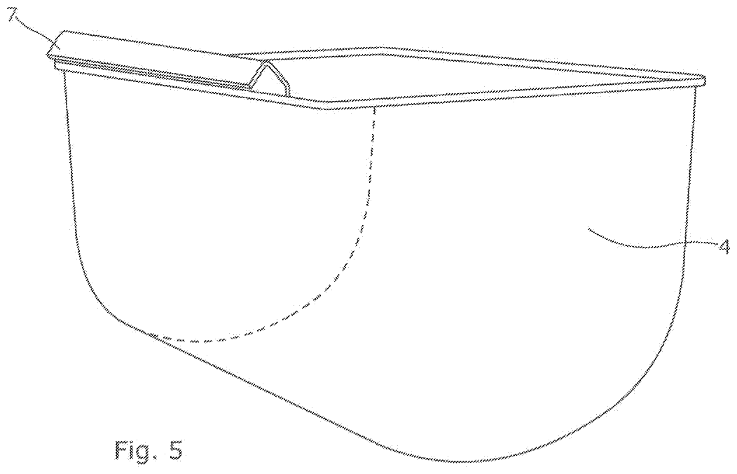

A sample bucket 4 can be seen in FIG. 5 of the accompanying drawings. It comprises a lip 7 on one edge; this lip 7 will overlay the trailing edge 64 of the following bucket 4 when the buckets are brought together.

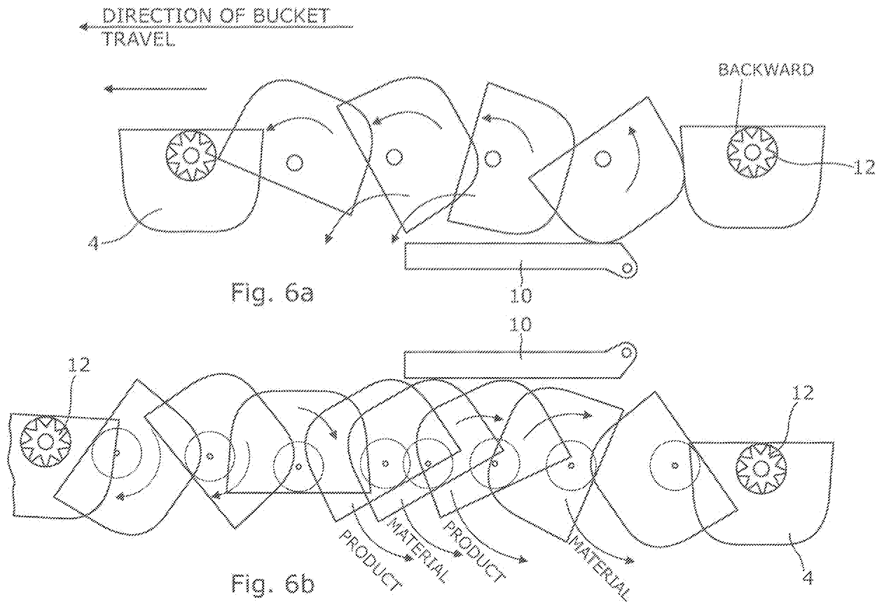

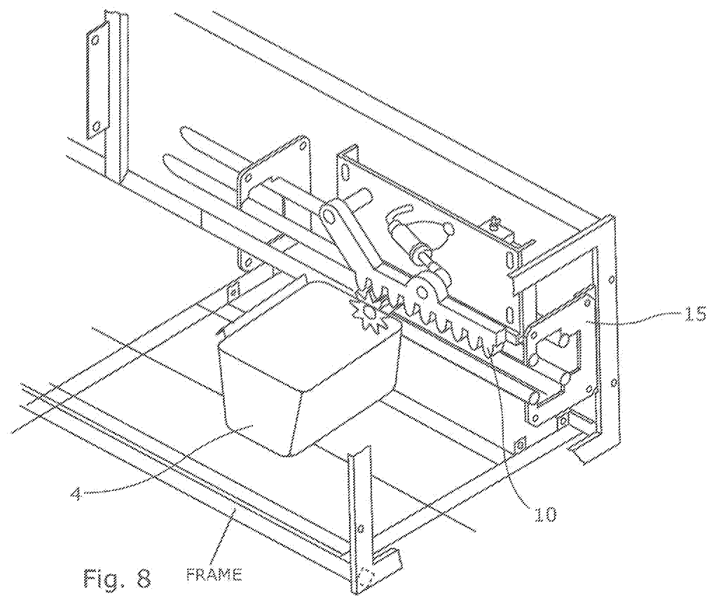

FIGS. 6 to 8 shown an alternative embodiment in which, rather than a cam 8, there is provided a gear sprocket 12 on each bucket 4, which engages a toothed rack 10 mounted adjacent to the sprockets at a discharge (as shown in FIGS. 6a and 6b) or loading location.

Depending on whether the toothed rack 10 is provided above or below the sprocket 12 will control which direction the buckets 4 rotate as they pass the toothed rack 10. In FIG. 6a, the rack 10 is below the sprockets 12 and the buckets rotate so that material in the buckets 4 is thrown in the direction of travel. In FIG. 6b, the rack 10 is above the sprockets, and the buckets 4 rotate in the opposite direction, such that the material in the buckets is thrown backwards in respect to the direction of travel of the buckets 4.

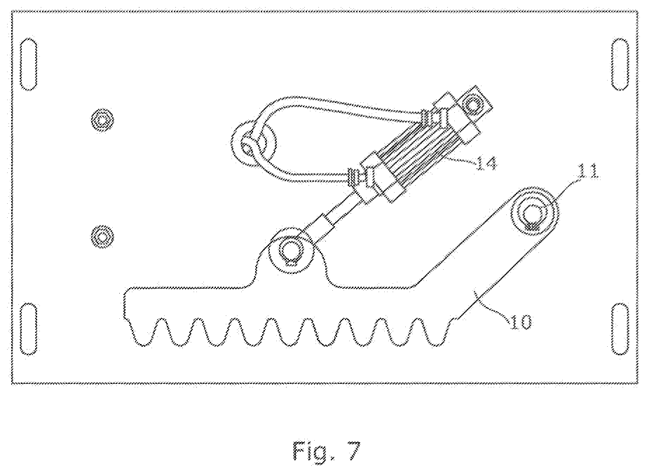

An actuator 14 can be provided to pivot the rack 10 about a pivot point 11 from the position shown in FIG. 7 of the accompanying drawings to a retracted position in which the rack 10 does not contact the sprockets 12.

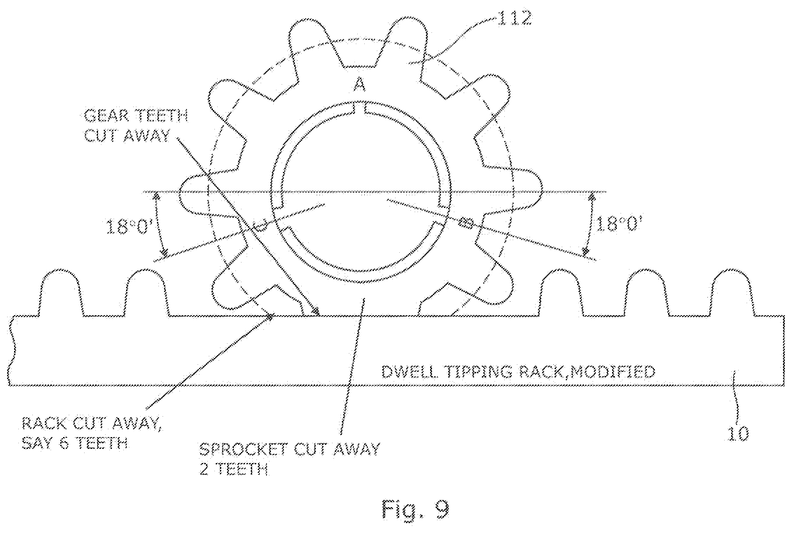

In an alternative embodiment shown in FIG. 9 of the accompanying drawings, the toothed rack 110 is missing some of the teeth, which will provide a dwell period (e.g. with the buckets 4 inverted).

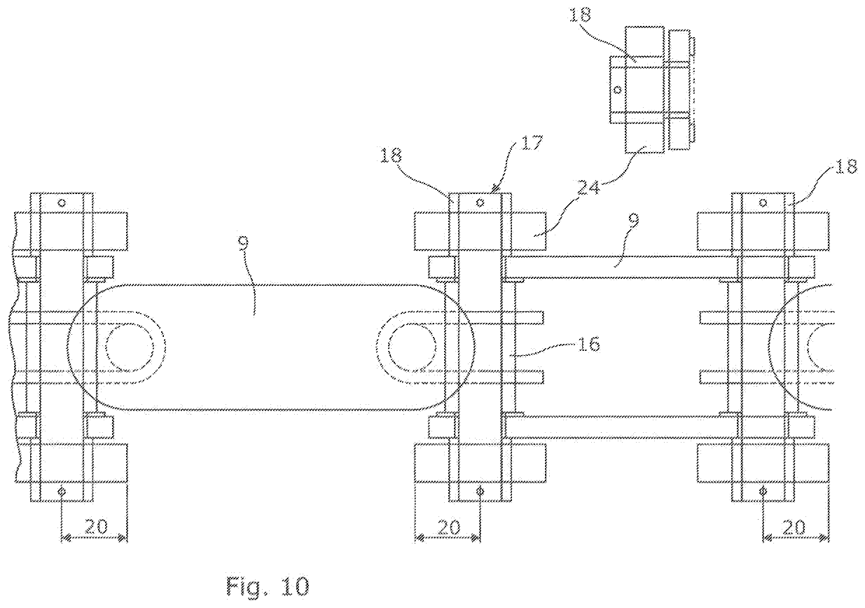

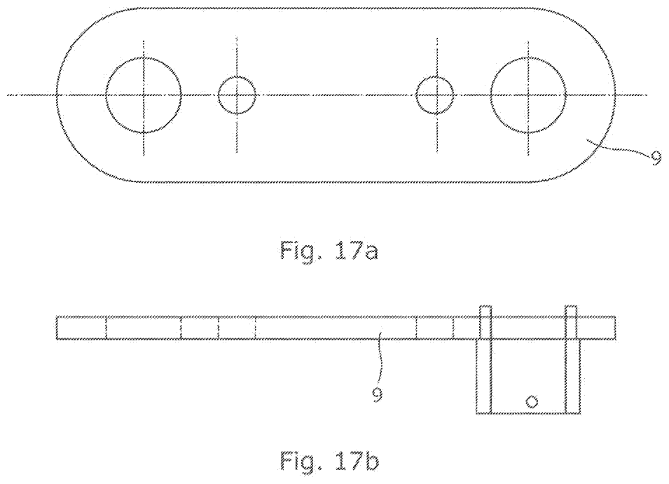

The chain 2 of the above embodiments can be seen in more detail in FIG. 10 of the accompanying drawings. It comprises links 9 provided in pairs, with successive pairs linked by pins 17 attached to arm head 16. The pins 17 are provided with the wheels 24 on bushes 18 on each end. An individual link 9 can be seen in more detail in FIGS. 17a and 17b of the accompanying drawings.

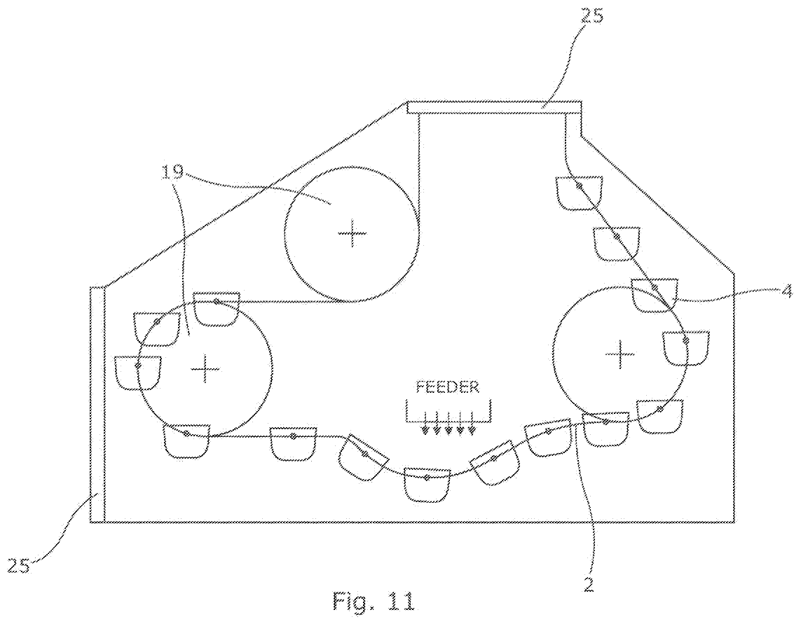

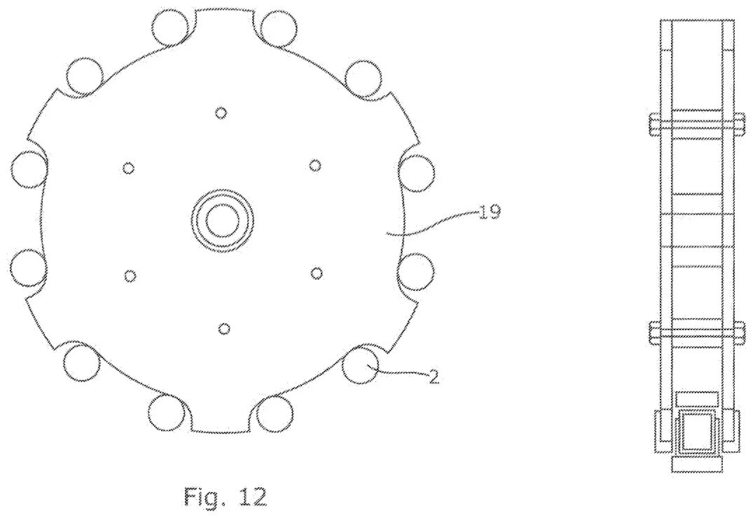

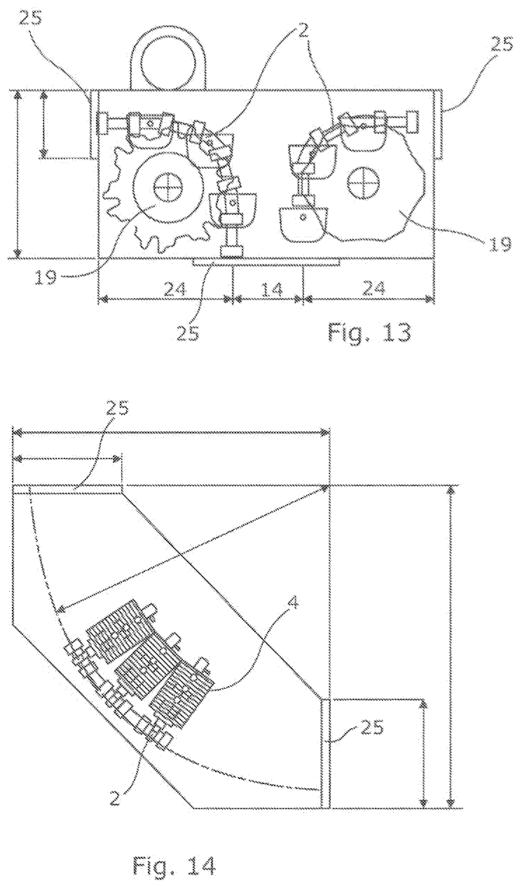

A sample conveyor system is shown in FIG. 11 of the accompanying drawings having a feeding station shown. The chain 2 passes around sprocket wheels 19. Such a sprocket wheel 19 is shown in FIG. 12 of the accompanying drawings and can support the chain 2 through horizontal or vertical turns. FIG. 13 shows such a vertical turn, with the chain 2 guided by sprocket wheel 19.

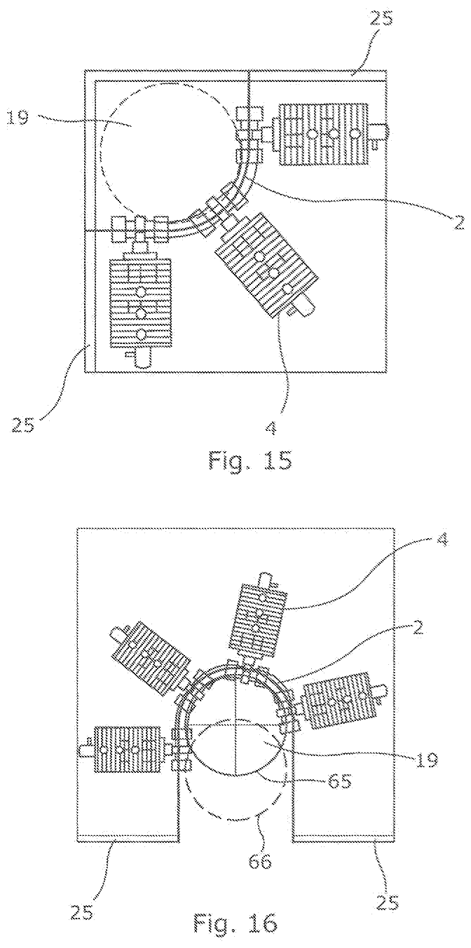

FIG. 14 shows a horizontal turn; as this is an inside turn (with the buckets 4 on the inside of the chain 2), the curve needs to be of sufficient size to provide sufficient clearance at the distal end of the buckets 4. In FIGS. 15 and 16, the turn is an outer horizontal turn, which has fewer constraints placed on the radius of curvature of the chain.

In FIG. 16, which shows a 180 degree bend, the sprocket wheel 19 can be used to control the tension in the chain 2 by moving between positions 65 and 66 along the path of chain 2 when it is not traversing the sprocket wheel 19.

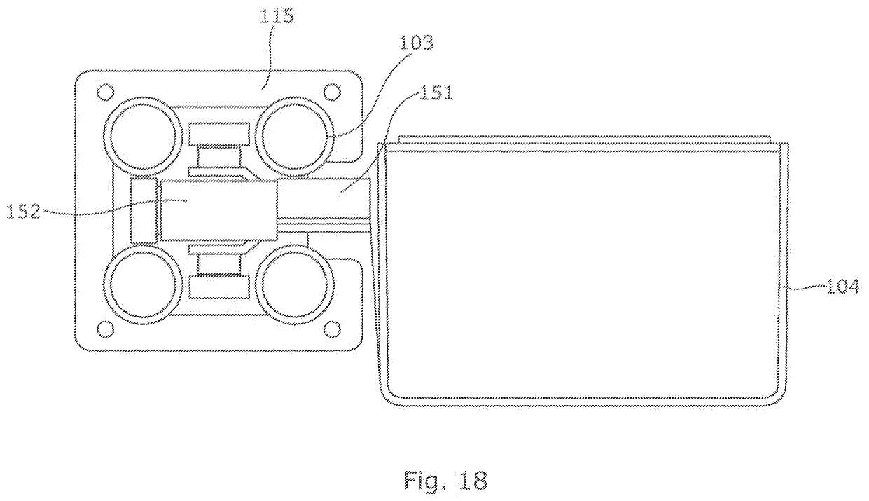

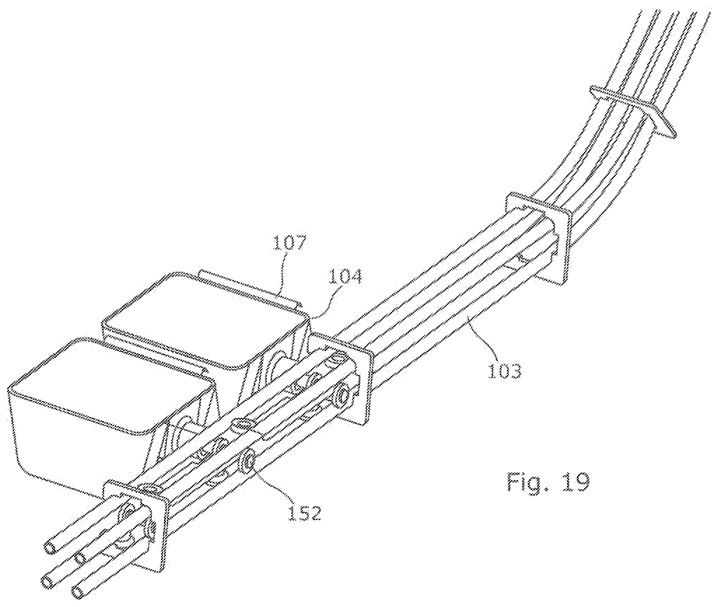

A further embodiment can be seen in FIGS. 18 and 19 of the accompanying drawings. In this embodiment, the bucket 104 is mounted horizontally on the arm 151 which also functions as spindle 5 did in the previous embodiment. The head 152 again preserves the orientation of the bucket 104 relative to the guide tracks 103 in guide 115.

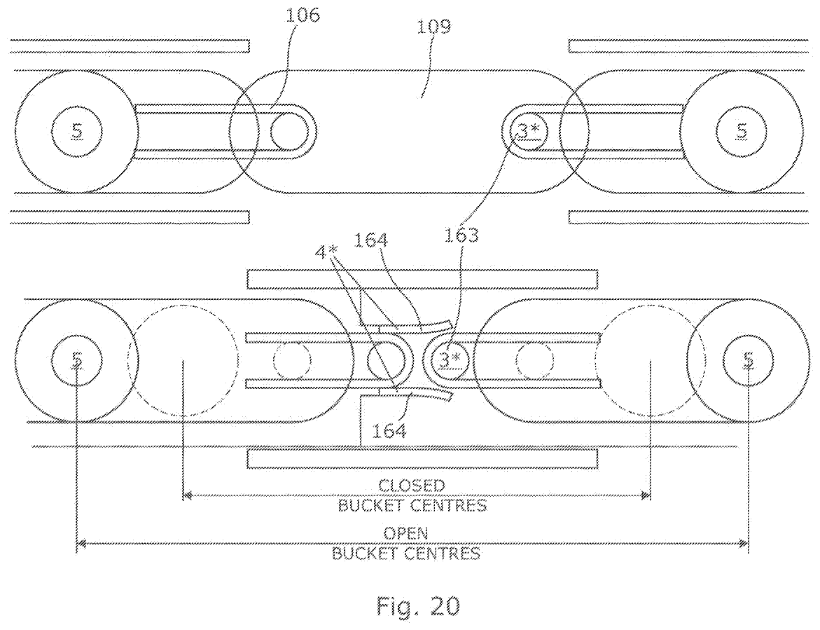

The bucket 104 has the same lip as in the previous embodiment. However, in order to control the spacing of the buckets, the chain is not of fixed pitch as shown in FIG. 20 of the accompanying drawings. The chain 102 is formed of links 109 joined by u-shaped members 106. Pins 163 join each link 109 to a u-shaped member 106 to form an endless chain. However, the pins can slide within the u-shaped members 106 to allow the pitch of the chains to vary through an optional guide 164.

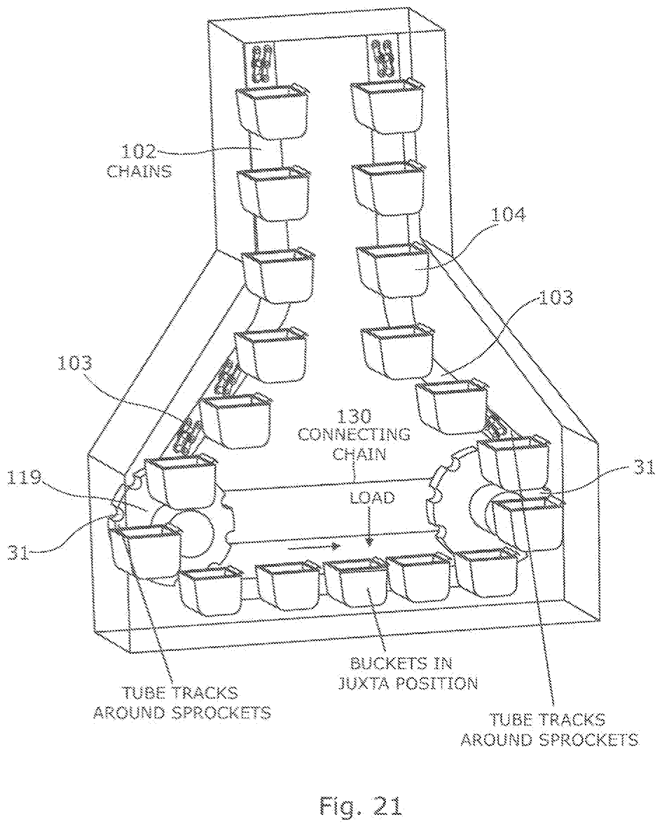

Thus, when the chain is compressed, the pitch of the buckets 4 reduces to allow for filling of the buckets as shown in FIG. 21 of the accompanying drawings.

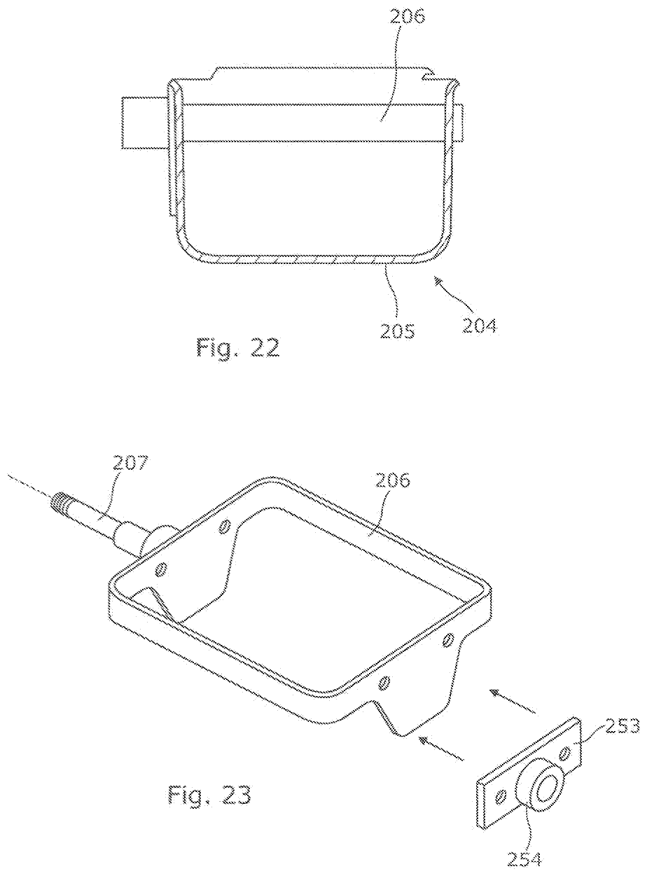

An alternative embodiment of the buckets used in the present invention can be seen in FIGS. 22 and 23 of the accompanying drawings. In this embodiment, rather than comprising a unitary body, the bucket 204 comprises an inner plastic shell 205 in an outer metallic (e.g. steel) support 206 of the form of a saddle or frame support. The support 206 carries the spindle 207 which would connect the bucket 204 to the chain. For the same strength of bucket, we believe it is possible to manufacture the bucket cheaper than if it were the unitary design discussed above. Furthermore, outrigger 253 can be provided, which comprises a wheel 254 which can roll along, for example, track 6. The outrigger 253 is mounted on the support 206 rather than the bucket shell 205.

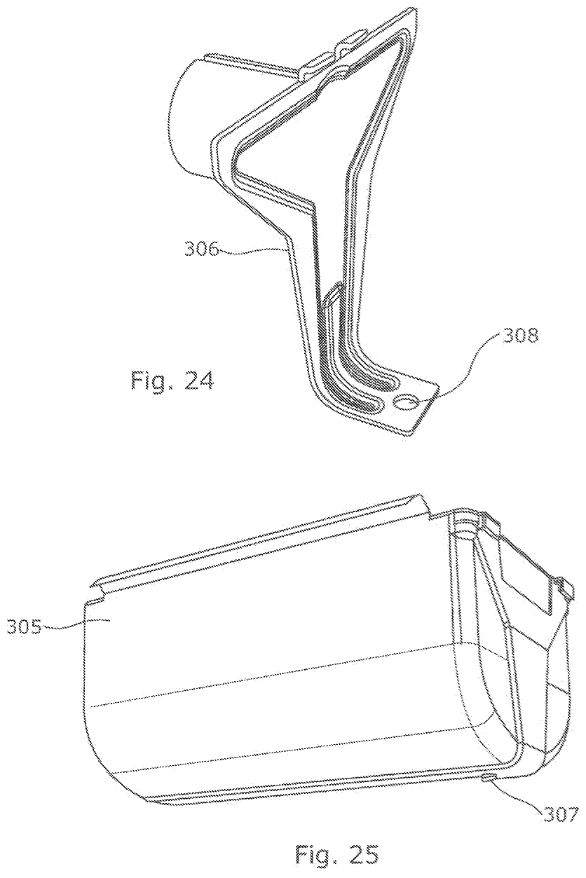

In a further embodiment of the bucket shown in FIGS. 24 and 25 of the accompanying drawings, the bucket body 305 is carried on a bracket 306. The bracket 306 clips onto the side of the bucket body 305, where a stud 307 on the bottom of the bucket will engage a hole 308 in the bracket 306 so as to secure the two together. The bracket contains a bearing which allows the bracket and bucket to rotate relative to the chain 2 through a mounting which would otherwise be as that shown in FIG. 2 of the accompanying drawings.

What is claimed is:

1. A conveyor system, comprising:
a track containing an endless chain; and
a plurality of buckets
each bucket comprising a bucket body defining a void in which contents can be contained, an arm pivotally mounted on the bucket body through a mounting for rotation relative to the bucket body about a bucket pivot axis through the mounting, the arm extending perpendicular to the bucket pivot axis and having an arm head at point distant from the axis;
each arm head being fixed to the chain through an arm mounting, the arm mountings being spaced apart along the endless chain by a chain pitch,
whereas the endless chain follows a first path, and the mountings of the buckets follow a second path; and
in which variation of the radius of curvature of the first path relative to the second path causes a separation of the buckets to vary.

2. The conveyor system of claim 1, in which the chain pitch is fixed.

3. The conveyor system of claim 1, comprising a guide arranged to guide the arm mountings.

4. The conveyor system of claim 3, in which the guide controls the angle of each arm relative to the track.

5. The conveyor system of claim 3, in which the guide defines at least one channel, with each arm mounting having at least one guide portion, such as a guide wheel, working in each channel.

6. The conveyor system of claim 5, in which each guide channel comprises a plurality of tubular sections with each channel formed between a pair of tubular sections.

7. A conveyor system, comprising:
a track containing an endless chain; and
a plurality of buckets
each bucket comprising a bucket body defining a void in which contents can be contained, an arm pivotally mounted on the bucket body through a mounting for rotation relative to the bucket body about a bucket pivot axis through the mounting;
each arm head being fixed to the chain through an arm mounting, the arm mountings being spaced apart along the endless chain by a variable chain pitch,
whereas the endless chain follows a first path;
in which variation of the chain pitch causes a separation of the buckets to vary.

8. The conveyor system of claim 7, in which the track comprises a guide arranged to guide the arm mountings and to control the angle of each arm relative to the track.

9. The conveyor system of claim 7, in which each bucket comprises a rotation means arranged to rotate it about the bucket pivot axis.

10. The conveyor system of claim 9, further comprising at least one engagement means arranged to engage each rotation means so as to cause each bucket to rotate.

11. The conveyor system of claim 10, in which the rotation means each comprise a gear mounted on the bucket, a cam or a follower.

12. The conveyor system of claim 11, in which the rotation means comprises a gear and the engagement means comprises a toothed rack.

13. The conveyor system of claim 12 in which at least one of the rotation means and the engagement means is arranged so as to introduce a dwell period of no or limited rotational movement of each bucket between two periods of rotational movement caused by the engagement means.

14. The conveyor system of claim 13, in which the toothed rack has a plain section without teeth between two toothed sections, so that the bucket does not rotate whilst the plain section is passing the rotation means.

15. The conveyor system of claim 1, in which each bucket comprises a lip which, in at least one position of the buckets, overlays an edge of a following bucket on the endless chain.

16. The conveyor system of claim 1, in which the first path does not lie in a single plane.

17. The conveyor system of claim 1, in which the mounting comprises a frame in or on which the bucket body sits.

18. The conveyor of claim 17, in which the frame surrounds the bucket body.

19. The conveyor of claim 17, in which the bucket body is made from a plastic material, whereas the frame is formed of metal material.
